(19) United States
(12) Patent Application Publication
(10) Pub. No.: US 2009/0020959 A1
(43) Pub. Date: Jan. 22, 2009

(54) Segmented packing ring

(76) Inventors: Bill Shaw, Victoria (AU); David Ivone, Victoria (AU); Mark Wardle, Victoria (AU); Jaeseok Lee, Victoria (AU)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/918,669

(22) PCT Filed: Apr. 13, 2006
(86) PCT No.: PCT/AT2006/000147

§ 371 Date: Jan. 16, 2008

(30) Foreign Application Priority Data
Apr. 20, 2005 (AT) A 662/2005

(51) Int. Cl. F16J 15/16; F16J 15/26

(52) U.S. Cl. 277/543

(57) ABSTRACT

The invention relates to a segmented packing ring for sealed packages, comprising at least two annular segments (1), which, in the assembled state, are held together in the circumferential direction by means of springs (3). According to the invention, the assembly may be simplified and relatively small springs used as protection against damage as a result of spring breakages, whereby, at each contact point (2) of adjacent annular segments (1), at least one separate tension spring (3) is arranged between anchor elements (5) provided on both ends in the region of the ends (4) of the annular segments (1) and the fixing of the tension springs (3) to the anchor elements (5) has a preferably clip or locking mechanism for single-person operation.

The invention relates to a segmented packing ring comprising at least two annular segments held together in circumferential direction by means of springs in the assembled state whereby at each contact point of adjacent annular segments there is at least one separate tension spring arranged between anchor elements provided on both sides of said annular segments.

Packing rings for sealed packings are known in the most varied designs and they are used preferably to seal reciprocating piston rods of reciprocating piston engines such as internal combustion engines, compressors, pumps and the like. The separation between mostly three individual annular segments (2, 4 or even more of rings are used at times) is either essentially radial or tangential. For example, the first case makes sense for rings which have always a specific clearance relative to the rod and wear is prevented thereby. In the second case, rings are used which experience wear during operation since they slide with friction and which can automatically adjust through the tangential cuts at the end of the annual segments which are biased by peripheral springs. However, radial packing elements are also employed very often in conjunction with tangential elements. Radial elements are provided thereby with a specific space between one another at the contact points whereby said space becomes continually smaller during the course of wearing. The radial gap is covered by a tangential ring disposed behind said gap which takes over the actual sealing function. The strokes of the tangential ring are sealed thereby by means of the radial segment so that no leakage can occur.

In the design of such packing rings which are used most commonly at the present (see for example U.S. Pat. No. 3,305,241; U.S. Pat. No. 3,711,104; U.S. Pat. No. 3,076,659 or U.S. Pat. No. 1,008,655) there is . . .

a single thin spiral tension spring arranged in a peripheral groove encompassing all annular segments whereby the hook-shaped ends of said spring are hooked together during installation in a pre-tensioned manner, which ensures the necessary firm assembly of the annular segments or which ensures the required pressure against the enclosed rod and which makes still possible a resilient movement between the annular segments, if necessary (as in case of wearing tangential cut rings moving on the reciprocating rod). However, this one-piece peripheral spring requires relatively complicated installation of the annular segments about the rod, which requires at least two installers since the individual annular segments must be brought and held at first in their proper respective positions and only then, the peripheral spring can be put in place, tensioned and hooked together. In most cases there is also the possible risk that such ring springs might brake and the relative large broken pieces would find their way into the cylinders or to the valves of the respective engine whereby they could cause great damage.

For example, a segmented packing ring is also disclosed in U.S. Pat. No. 2,055,153 wherein several identically designed annular segments are held together and are pre-tensioned by means of small pressure springs arranged in mirror-image between the ends of two segments and a center piece which create only very small pieces in the event of a spring breakage, which means therefore a relatively low risk potential, but which is otherwise associated with an enormously large effort in the manufacturing and installation process.

A similar sealing ring is finally disclosed in JP 2000-291806 wherein separate pins have primarily the function, together with corresponding stopping surfaces on the seal housing, to prevent leakage between the segments of the sealing ring and a co-rotating and self-rotating shaft to be sealed. In the arrangement in this patent document and according to the state-of-the art there are disclosed groove-like recesses or holes which are provided in the radial section of the annular segments and which are disposed between the installed peripheral spring and the inner seal diameter and which makes the radial ring width relatively . . .

wide. As an invention there is disclosed according to this Japanese patent document to insert these stopping pins in the region of the peripheral spring (and push them all the way through, if necessary), which required deformation of said peripheral spring in specific areas or which requires its distributed sectional use across the individual segments connected by said pins. They are not speaking thereby about simplification in the installation of the annular segments since no simplification takes place but it is made more complicated through the mutual attachment of two spring ends to the pin to be inserted into the ring. However, it is disclosed in this patent document that a separate tension spring is arranged on the anchor elements provided on each contact point of adjacent annular segments.

The object of the present invention is to improve packing rings of the aforementioned type in such a manner that the cited disadvantages of the disclosed arrangements are prevented and that especially its installation is simplified and that the risk potential of damage caused by the springs is reduced during the operation of the arrangement.

This object is achieved according to the present invention for a packing ring of the aforementioned type in that the anchor elements are provided in the region of the ends of the annular segments and that fastening of the tension springs occurs on a respective mutual anchor element for each end of the tension spring. The tension spring effective in circumferential direction is thereby divided into individual, very short elements which cannot cause large problems or at least only considerably smaller problems as it would be the case with a single long spring encompassing all annular segments in its entirety. Installation is considerably simplified since the fastening of the individual separate tension springs does occur neither on the other end of the same tension spring nor on the associated end of one of the other tension springs, but fastening occurs respectively at its own end region of the anchor element provided on the annular segment per each end of the tension spring and since, in any case, always one end of the tension spring has to be fastened to its respective anchor element and only one end has to be fastened to the laterally-fixed spring.

According to an especially preferred embodiment of the invention it is proposed that the fastening part of the tension springs on one anchor element, preferably on all anchor elements, is designed for installation and dismantling with a producible clip-on or locking mechanism for single-person operation. This makes very simple installation or dismantling of the packing ring possible which is especially advantageous when the individual elements of the seal packing must be exchanged “on the rod”, which means directly on the piston engine, e.g. during repair service.

The tension springs, which are already provided with unilateral separate retention elements according to the above mentioned JP 2000-291806 A, are preferably designed having a center piece of the tension spring in the form of straight wire sections connected in one piece to the coiled end sections which engage the anchor elements preferably formed as recesses on the annular segments. These off-set coiled end sections can be coiled simultaneously in a very simple and cost-effective manner during the production of the tension spring—the recesses on the annular elements can be made in the form of simple borings, for example.

The coiled end sections are preferably at least slightly larger in their dimensions as the associated dimensions of the anchor elements on the annular segments, which makes possible in a simple manner the clipping-on and controlled retention of the connections of the tension springs in the anchor elements.

In an additional advantageous embodiment of the invention it is proposed that the recesses are formed respectively by a radial boring extending essentially radially at the circumference of the annular segments and extending essentially axial from the face of the annular segment whereby the radial boring cuts across the axial boring and whereby both boring are preferably blind end borings. The radial boring is slightly smaller in diameter, preferably 5-10%, and the axial boring is slightly larger in diameter, preferably 5-10%, than the diameter of the coiled end sections of the tension spring, and whereby the coiled end sections are coils which are spaced apart, preferably in the range of 0.1 to 0.3 mm, in their released condition and having a length that is smaller than their diameter.

This makes simple production of the packing ring possible, on the one hand, and makes possible in a simple manner the production of a type of clip-on locking connection, on the other hand, whereby the coiled end sections pressed into the radial boring from the outside have to overcome some resistance and they are pressed together after which they can expand again in the larger axial boring and any easy disengagement of this connection is prevented thereby. The adjustments of the mentioned parameters have been proven in practical operations providing a retention force of the thereby created connections in the range of approximately 5-10 Newton, which makes safe operation possible together with simple installation and dismantling.

In an additional embodiment of the invention, the tension springs are arranged in an at least largely embedded manner in the recesses at the ends of the annular segments, which makes the placement into the packing simple and it protects the springs during operation.

According to an especially preferred additional embodiment of the invention it is proposed that the anchor elements can be arranged at different circumferential positions on the annular segments to allow for a combination of tension springs of different lengths or to make available different peripheral forces with identical tension springs. For example, this requires in the above described design of the anchor elements being used as a combination of radial and axial borings that these borings are placed at another location at the end of the respective annular segment whereby adjustment in construction to different conditions is made possible in a simple manner.

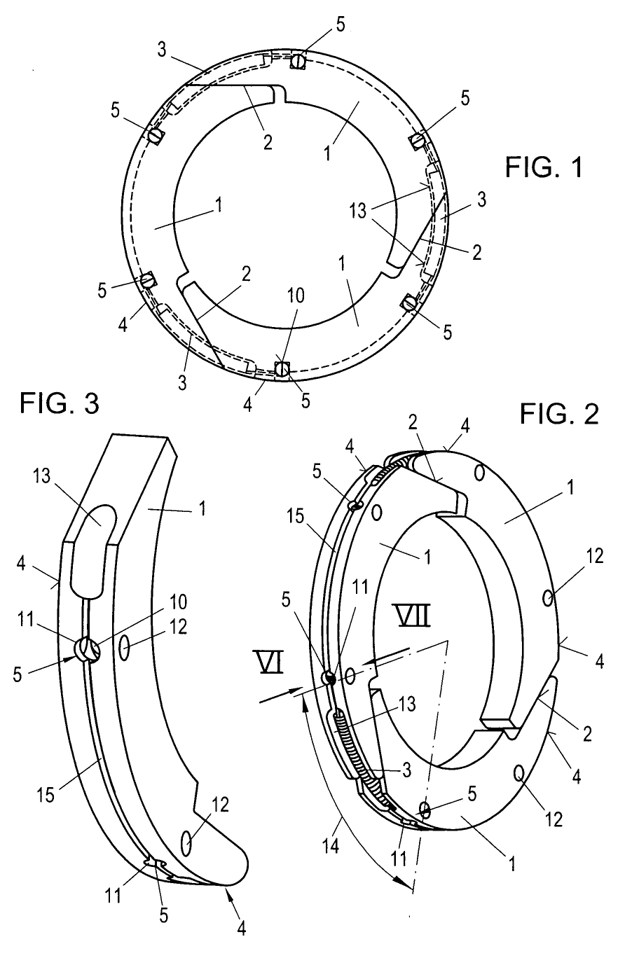

The invention is described in more detail with the aid of the embodiment example of a tangential-cut packing ring illustrated in the drawing. FIG. 1 shows thereby a side view (in direction of the axis of the piston rod (not shown)) of the packing ring in a mounted condition; FIG. 2 shows the ring in a perspective view;

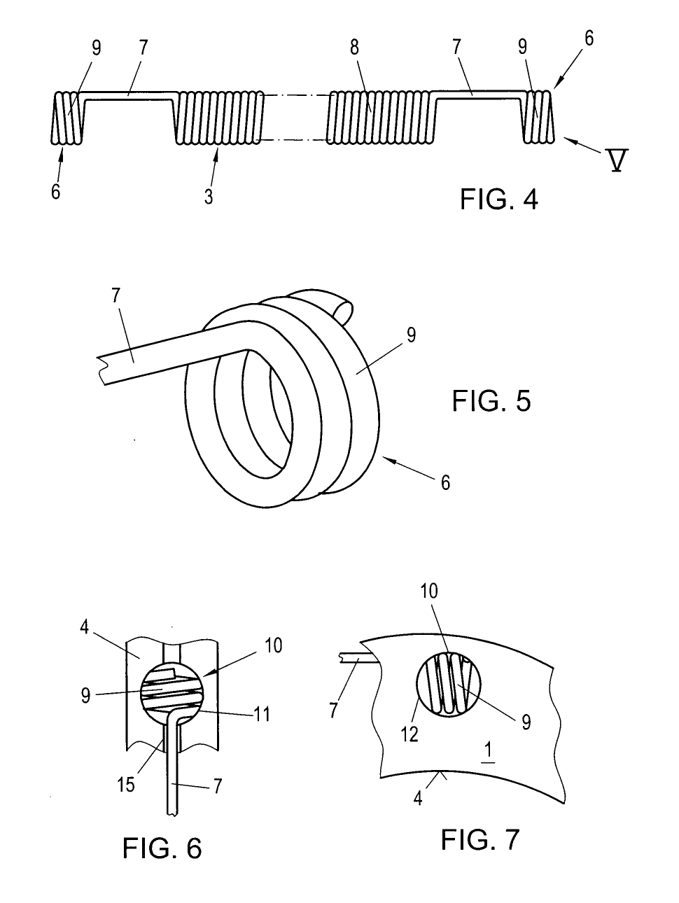

FIG. 3 shows a single ring element in an enlarged perspective illustration; FIG. 4 shows a single tension spring in an enlarged illustration; FIG. 5 shows the detail V from FIG. 4 in a perspective view; and FIG. 6 and FIG. 7 show respectively enlarged schematic detailed views along the arrows VI and VII of FIG. 2.

The illustrated packing ring consists of three annular segments 1, which lie essentially tangential to one another at the contact points 2 and which are held together by means of tension springs 3 in peripheral direction or whereby said annular segments are pressed against an encompassed element to be sealed, which is here the not-illustrated element (the piston rod). A separate tension spring 3 is here arranged at each of the contact points 2 between both sides of the anchor elements 5, which are arranged in the region of the ends 4 of the annular elements 1. Besides, there could also be arranged, or course, two or more parallel arranged tension springs 3 at each contact point 2 if a larger ring width allows or requires additional tension springs.

The tension springs are provided with separate retention elements 6 in the region of the two ends of said tension springs whereby said retention elements are formed by the coiled end sections 9 connected to the center piece 8 by means of the straight wire sections 7 (see specifically FIG. 4 through 7). The associated anchor elements 5 at the ends 4 of the annular segments 1 are in the form of recesses 10 into which the coiled end sections 9 of the tension spring 3 engage, as it can be seen especially in FIG. 6 and FIG. 7. The recesses 10 are respectively formed by a radial boring 11 extending essentially radial about the circumference of the annular segments 1 and an axial boring 12 crossing the radial boring 11 and extending essentially axial from one of the faces of the annular segments 1, and whereby both borings are here in the form of blind end borings. As it can be seen in FIG. 6, the radial borings 11 are smaller in their diameter than the diameter of the coiled end sections 9 of the tension spring 3. As it can be seen in FIG. 7, the axial borings 12 are slightly larger in their diameter than the diameter of the of the coiled end sections 9. In addition, the coiled end sections 9 have spaces between the coils in the released condition and a length that is smaller than their diameter (as it can be seen specifically in FIG. 6 and FIG. 7) so that they can be pushed together to some degree during installation. A type of clip-on mechanism is created thereby for fastening the tension springs 3 to the annular segments 1. A specific resistance must be overcome during insertion of the coiled end sections 9 as the result of the somewhat smaller radial boring 11, which is made possible through the corresponding compression of the coiled end sections 9. The coiled end section 9 can expand again thereafter in the region of the axial boring 12 whereby the coiled end section 9 is fixed in the recess 10 or in the anchor element 5 and said coiled end section can only be removed again by overcoming a specific retention force. This retention force can be varied through corresponding adjustment of the dimensions of the cooperating elements so that secure retention is made possible at the most simplest way of installation.

The tension springs 3 are embedded in the recesses 13 at the ends 4 of the annular segments 1 (as it can be observed especially in FIG. 1 through 3) which provides protection against damage thereby. It can additionally be seen especially in FIG. 1 through FIG. 3 that the arrangement can be very simply changed for tension springs 3 of different lengths or to make available different peripheral forces by keeping the same tension springs 3 in that the circumferential position of the anchor elements 5 or the recesses 10 are varied, whereby the distance 14 drawn in FIG. 2 changes correspondingly between the two associated anchor elements 5. It can also be seen especially in FIG. 2 and FIG. 3, that the narrow circumferential groove 15 does not have to run around the entire circumference of the packing ring as illustrated—to receive the wire sections 7 between the center piece 8 and the coiled section 9 it would be sufficient to provide only small grooved sections between the recesses 10 and 13.

It can be additionally seen or it can be easily conceived, especially with the aid of FIG. 1 and FIG. 2, that the installation of packing rings of this type can be performed very simply even by one person whereby, in the simplest case, the respective annular segments 1 are successively placed on the piston rod to be sealed and then the tension springs 3 are fastened in order to the anchor elements 5 by pressing the coiled end sections 9 into the recesses 10—the installation is completed after performing the last fastening of this type. Besides, it would naturally also be possible in the scope of the invention to perform the fastening process individually—or all except for one—and to fasten the retention elements to the anchor elements in some other manner or to perform this step relatively permanent in advance and then complete only the remaining fastening step of the part left open during installation (it makes no difference if the packing rings are cut radial or tangential or if they are made otherwise in the traditional manner in the form of a ring separated in two, three or more parts).

1. A segmented packing ring comprising at least two annular segments (1) held together in circumferential direction by means of springs (3) in the assembled state whereby at each contact point (2) of adjacent annular segments (1) there is at least one separate tension spring (3) arranged between anchor elements (5) provided on both sides of said annular segments (1), whereby said anchor elements are provided in the area of the ends (4) of the annular segments (1), and whereby fastening of the tension springs (3) occurs respectively on one particular anchor element (5) for each end of the tension spring, and whereby said tension springs are provided with separate fastening elements in the area of both ends, wherein the fastening elements (6) at the end of the tension springs (3) are formed in one piece and connected to the coiled end sections (9) and the center piece (8) of the tension spring (3) by means straight wire sections (7), wherein the anchor elements (5) are formed as recesses (10) on the annular segments (1), and wherein said coiled end sections (9) of the tension spring (3) engage directly into said recesses.

2. A packing ring according to claim 1, wherein the coiled end sections (9) must be a somewhat larger in their dimensions that the associated dimension of the anchor elements (5) on the annular segments.

3. A packing ring according to claim 2, wherein the recesses (10) are formed respectively by a radial boring (11) extending essentially radially at the circumference of the annular segments (1) and extending essentially axial from the face of the annular segment (1) whereby the radial boring (11) cuts across the axial boring (12) and whereby both boring are preferably blind end borings, and wherein the radial boring (11) is 5-10% smaller in diameter, and the axial boring (12) is 5-10% larger in diameter, than the diameter of the coiled end sections (9) of the tension spring (3), and wherein the coiled end sections (9) are coils which are spaced apart about 0.1 to 0.3 mm, in their released condition and having a length that is smaller than their diameter.

4. A packing ring according to claim 1, wherein the tension springs (3) are arranged in an at least largely embedded manner in the recesses (13) at the ends (4) of the annular segments (1).

5. A packing ring according to claim 1, wherein the anchor elements (5) can be arranged at different circumferential positions on the annular segments (1) to allow for a combination of tension springs (3) of different lengths or to make available different peripheral forces with identical tension springs (3).

6.-8. (canceled)
